(19) United States
(12) Patent Application Publication
(10) Pub. No.: US 2008/0186537 A1
(43) Pub. Date: Aug. 7, 2008

(54) INFORMATION PROCESSING APPARATUS AND METHOD FOR CONTROLLING THE SAME

(75) Inventor: Naohiro Isobe, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/024,742

(22) Filed: Feb. 1, 2008

(30) Foreign Application Priority Data
Feb. 2, 2007 (JP) 2007-024589

(51) Int. Cl. G06F 15/00

(52) U.S. Cl. 358/1.15

(57) ABSTRACT

An information processing apparatus operates to generate template data including one or more variable areas in which content data acquired from a database can be disposed. The information processing apparatus includes a setting unit that sets preview conditions. A selection unit selects a variable area to be previewed and into which content data can be disposed, from the one or more variable areas, based on the preview conditions. A generation unit generates content data to be disposed in the variable area selected by the selection unit, as preview data disposed in the variable area. A display control unit causes a display device to display the preview data. The generation unit generates a plurality of preview data as a combination of content data disposed in each variable area. The display control unit causes the display device to display the plurality of preview data generated by the generation unit.

### BACKGROUND OF THE INVENTION

1. Field of the Invention

The present invention relates to an information processing apparatus that enables a user to preview processed data (e.g., print data), and also relates to a method for controlling the information processing apparatus and a related program.

2. Description of the Related Art

In general, electro-photographic printing apparatuses and inkjet printing apparatuses can realize high speed and high quality print processing. To develop a new market of electronic data-based digital printing, a new business model, so called “Print on Demand (referred to POD)”, has been recently introduced. Compared to the conventional printing press techniques, POD has the capability of processing a relatively small number of jobs and finishing the jobs in a short period of time without the need for a large-scale device or system. Under POD, this typically is achieved, for example, by fully utilizing a digital image forming apparatus, such as a digital copy machine or a digital multifunction peripheral. In such a POD market, computer-based controls and managements are essentially required to promote the digitization in various printing processes, improve the quality level of print products, and catch up to the capabilities of the conventional print industries.

As a printing technique derivative from the POD, Variable Date Print (hereinafter, referred to as VDP) can fully utilize various functions of a digital image forming apparatus. A VDP system enables a user to change print content of each record according to information stored in a database. For example, a user of the VDP system can print direct mailings which include product information varying according to client information or utilization bills which include numerical values (e.g., expense for utilities) varying according to actual utilization. Accordingly, the use of VDP systems is rapidly expanding in a market of the direct mailing.

The print data processed in a VDP system can be referred to as VDP data. An application (software program) enabling a user to generate VDP data can be referred to as a VDP application. A VDP application includes a user interface that enables a user to perform a page layout by determining the layout of an area (such as the area's position and size) where content data can be disposed and the type of content data (text, image, graphic, etc.)to be placed in the area. Under VDP, the determination typically is based on content data acquired from a database. This differs from conventional print layout applications which require the user to layout content data directly.

An area, if content data disposed therein varies according to information acquired from a database, can be referred to as “variable area.” An area, if content data disposed therein does not vary regardless of information stored in a database, can be referred to as “fixed area.” A user can set a conditional expression using each column of a database for a variable area, so that the content disposed in the area can be changed according to information stored in the database. For example, a user can set a conditional expression for disposing a photo image directed to younger people in the variable area if a value representing the age (information stored in a database) is between 20 and 29, and disposing a photo image directed to older people if the age is 60 or over.

As described above, the VDP application enables a user to generate VDP data that can relate an area of a page with information stored in a database, and transmits the generated VDP data to a digital image forming apparatus. The digital image forming apparatus performs print processing with reference to the relationship defined in the received VDP data.

A user of the VDP application is allowed to change print contents (e.g., text, image, and graphic data) using information stored in a database. However, if a large amount of information is stored in the database, a user may hesitate to perform layout confirmation for all information stored in the database. Namely, it is not realistic to perform preview displays for all print products which include actual print contents (content data). Therefore, instead of performing preview displays for all actual output products, a user usually confirms only the position of each area for the layout confirmation. However, if the layout confirmation is limited to confirming the position of each area, the following problems arise.

Although the position of each area can be confirmed, the user cannot perform a layout confirmation that includes actual data. In particular, that user cannot perform a work equivalent to the comprehensive layout, proof, and correction found in an conventional printing operations.

More specifically, a user cannot check whether there is any problem in a print product (e.g., any text portion which a user cannot read or any image portion that a use cannot view) due to an undesirable combination of texts and images. As described above, it is desirable to perform a preview display for each product actually printed. However, it is difficult to perform preview displays (layout confirmation) for all print products, if the amount of information stored in a database reaches the level of several thousand records or more.

The above-described problem does not arise if the number of preview displays is small. Hence, as discussed in Japanese Patent Application Laid-Open No. 2005-122727, for the purpose of reducing the number of preview displays, a conventional method includes obtaining statistic data (e.g., maximum, minimum, and average sizes) of actual data disposed in each variable area, generating typical data, and utilizing the generated typical data for a preview or a proof output.

However, according to this method, although the number of preview displays can be reduced, the preview data that a user can confirm is limited to only the typical data. A user may not be able to perform layout confirmation with satisfaction.

Furthermore, as discussed in Japanese Patent Application Laid-Open No. 2005-216183, a conventional preview function of a VDP application can identify a target record, retrieve another record greatly different from the target record, and designate both the retrieved record and the target record as preview objects for the purpose of reducing the number of preview displays. However, this method may fail to extract a proper record for the layout confirmation that a user wants. Thus, the layout confirmation performed according to this method may be dissatisfactory for a user.

As described above, although the number of preview displays can be reduced, conventional methods cannot realize satisfactory layout confirmation.

### SUMMARY OF THE INVENTION

Exemplary embodiments of the present invention are directed to a system capable of performing layout confirmation with a limited number of preview displays without executing the preview operation for all output products actually printed.

According to an aspect of the present invention, an information processing apparatus operates to generate data including one or more variable areas in which content data acquired from a database can be disposed. The information processing apparatus includes a setting unit configured to set preview conditions; a selection unit configured to select a variable area to be previewed and into which content data can be disposed, from the one or more variable areas, based on the preview conditions; a generation unit configured to generate content data to be disposed in the variable area selected by the selection unit as preview data disposed in the variable area; and a display control unit configured to cause a display device to display the preview data, wherein the generation unit generates a plurality of preview data as a combination of content data disposed in each variable area, and the display control unit causes the display device to display the plurality of preview data generated by the generation unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments and features of the invention and, together with the description, serve to explain the principles of the invention.

FIG. 1 illustrates a VDP system according to an exemplary embodiment of the present invention.

FIG. 2 is a block diagram illustrating a hardware arrangement of a client PC.

FIG. 3 illustrates an example of a user interface displayed on a display device that enables a user to generate VDP data.

FIG. 4 is a flowchart illustrating a method for generating a preview image according to an exemplary embodiment of the present invention.

FIG. 5 is a flowchart illustrating details of the processing performed in step S401.

FIG. 6 illustrates an example of a data structure of a data list.

FIG. 7 illustrates an example of a user interface that the display device can display in the processing of step S403.

FIG. 8 is a flowchart illustrating detailed processing in step S402.

FIG. 9 illustrates an example of an editing screen.

FIG. 10 illustrates an example of a client database.

FIG. 11 illustrates an example of content data prepared beforehand by a user.

FIG. 12 illustrates an example of conditional expressions set beforehand by a user.

FIG. 13 illustrates an example of a relationship between content data.

FIG. 14 illustrates an example of a data list.

FIG. 15 illustrates an example of a data list that includes highlighted data of variable areas.

FIG. 16 illustrates an example of a preview display actually performed.

### DETAILED DESCRIPTION OF THE EMBODIMENTS

The following description of exemplary embodiments is illustrative in nature and is in no way intended to limit the invention, its application, or uses. Processes, techniques, apparatus, and systems as known by one of ordinary skill in the art are intended to be part of the enabling description where appropriate. In the specification, the same reference mark is used to refer to the same item in more than one figure. Once an item is described in one figure, it may not be further described in the remaining figures where such further description would be redundant. A wide variety of exemplary embodiments of the present invention are described in detail below with reference to the drawings.

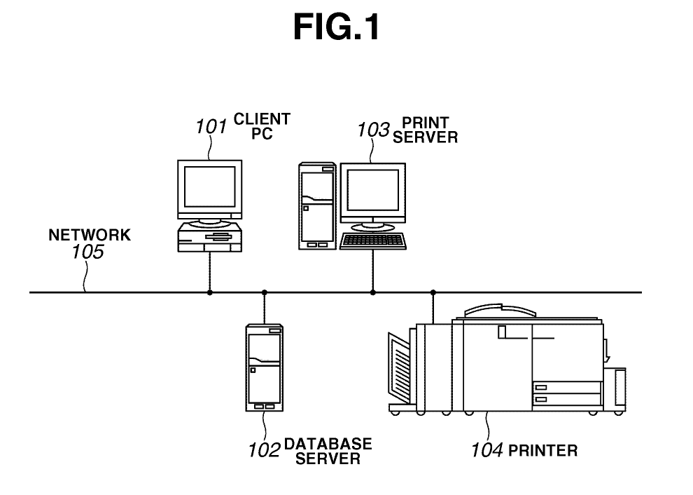

FIG. 1 illustrates a VDP system according to an exemplary embodiment of the present invention. The VDP system includes a client PC 101, a database server 102, a print server 103, and a printer 104 which are interconnected by a network 105. More than one client PC 101, database server 102, print server 103, and/or printer 104 may alternatively be used, for example, by connecting such additional devices to the network 105. Moreover, client PC 101, for example, may alternatively be replaced by another form of information processing apparatus, such as a Macintosh Computer, a UNIX workstation, or a computer having a Linux, Solaris, or VMS, operating system, for example.

A VDP application is installed on and runs on the client PC 101 in this embodiment of the present invention, although the VDP application can alternatively be installed and run on the database server 102, print server 103, and/or the printer 104 in accordance with the present invention. The VDP application of the client PC 101 enables a user to generate VDP data. In an exemplary embodiment, the VDP data can be composed of a template (which may be referred to as a “form”) including at least one area where content data can be disposed, content data (also referred to as a layout object), and a layout command indicating an area of the template where each block of content data can be disposed.

The printer 104 can dispose content data into each area of the template according to the layout command included in the VDP data. The VDP application enables a user to preview a layout of content data disposed on the template according to the layout command. Details of the client PC 101 are described below.

The database server 102 includes a database that stores the VDP data. A user can relate VDP data with a database using the VDP application. The print server 103 performs a management of data generated by the VDP application before the printer 104 executes print processing. The printer 104 can be either a color printer or a monochrome printer. The client PC generates data including one or more variable areas in which content data acquired from a database can be disposed.

An exemplary operation of the VDP system is described below. First, a user generates VDP data using the VDP application installed on the client PC 101. Next, the client PC 101 transmits the generated VDP data to the print server 103. Then, the print server 103 generates print data including content data disposed in each area of a template contained in the VDP data and, if necessary, generates history information for the print job and/or caches the print job. Then, the print server 103 transmits the generated print data to the printer 104. The printer 104 prints the print data on paper or other printable medium. The print data may be, for example, page description language (PDL) data that the client PC 101 can generate and the printer 104 can interpret and print.

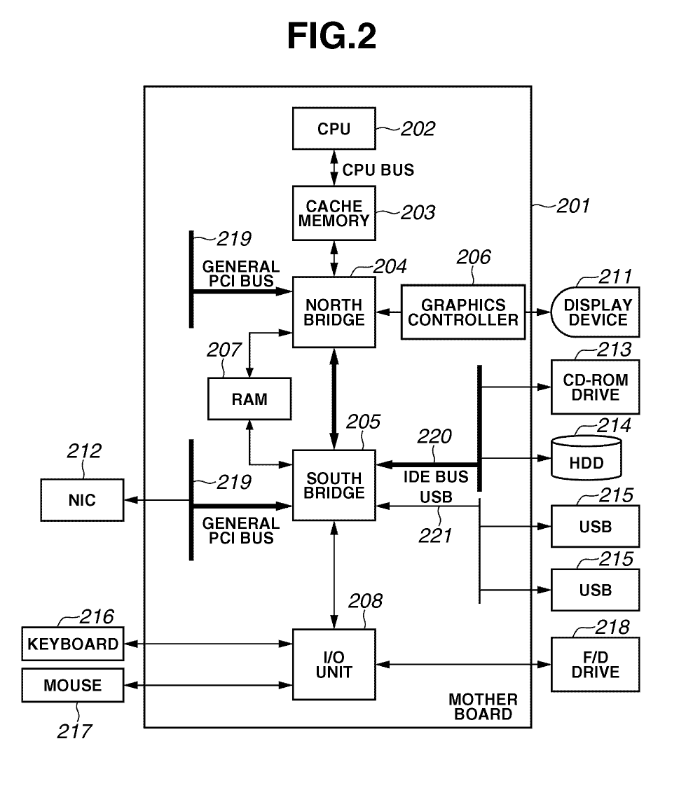

An exemplary hardware arrangement of the client PC 101 is described below with reference to FIG. 2. The client PC 101 includes a mother board 201 on which a central processing unit (CPU) 202, a cache memory 203, a north bridge 204, a south bridge 205, a graphics controller 206, a random access memory (RAM) 207 and an input/output (I/O) unit 208 are mounted.

The CPU 202 communicates with the north bridge 204 and the south bridge 205 via the cache memory 203 and controls the client PC 101 that performs various processing based on software programs. The CPU 202 accesses the RAM 207 for data exchange between the north bridge 204 and the south bridge 205 and temporary storage of data in the client PC 101.

The north bridge 204 includes a general PCI bus 219 for communication with an external SCSI device that can be optionally connected to the PCI bus. The north bridge 204 manages the graphics controller 206 that controls a display of an external display device 211.

The south bridge 205 is also connected to the general PCI bus 219 for communication with a network device via a network interface card (NIC) 212. Furthermore, the south bridge 205 includes an Integrated Drive Electronics (IDE) bus 220 to which a compact disk-ROM (CD-ROM) drive 213 and a hard disk drive (HDD) 214 are connected. A CD-recordable (CD-R) drive and a CD-rewritable (CD-R/W) drive alternatively can be connected to the IDE bus.

The CD-ROM drive 213 can drive a CD-ROM which is preferably used for data storage (such as archival storage) of a large amount of data and for installation of software programs to the client PC 101. Furthermore, the HDD 214 can drive a hard disk that stores control software and various data of the client PC 101. Moreover, the south bridge 205 is connected to a Universal Serial Bus (USB) 221 which includes one or more USB ports 215 via which the south bridge 205 can access external USB devices (e.g., USB memories).

The I/O unit 208 controls input/output of data via a keyboard 216, a mouse 217, and a flexible drive (F/D drive) 218. The hardware arrangement of the client PC 101 is not limited to the above-described example.

The VDP application, for example, is stored in the HDD 214 or other recording medium. The CPU 202 executes the VDP application using, if necessary, the cache memory 203, the north bridge 204, the south bridge 205, the graphic controller 206, the RAM 207, and the I/O section 208. The VDP application has two main functions. First, the VDP application enables a user to generate VDP data via a user interface. Second, the VDP application generates a preview image based on the VDP data.

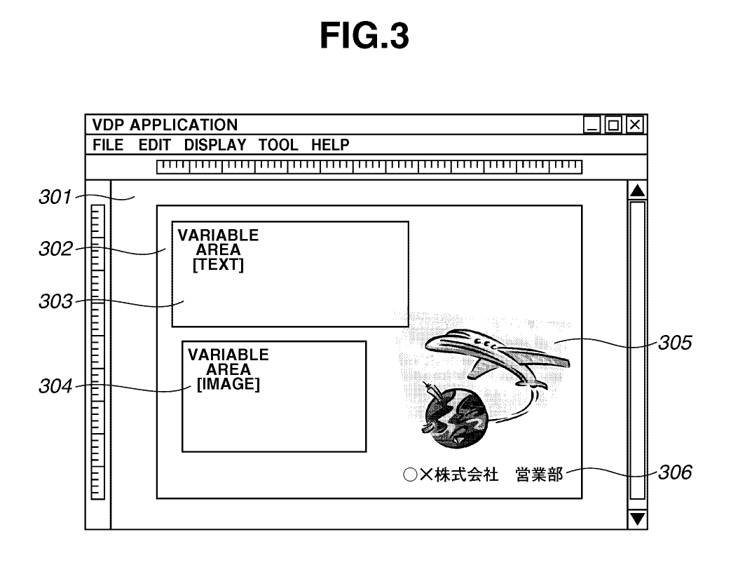

FIG. 3 illustrates an example user interface that the display device 211 can display when the VDP application generates VDP data. The user interface illustrated in FIG. 3 is an editing screen of the VDP application. The editing screen is composed of an editing area 301 and a document area 302 indicating the boundary of a document. A user can input desired content data into the document area 302 to generate VDP data.

The example of FIG. 3 includes a total of four content data areas which are selected by a user and disposed on the document area 302. Two of the content data areas are variable areas 303 and 304. The content data of variable area 303 is a text file. The content data of variable area 304 is an image file. The content data of the variable areas 303 and 304 are changeable according to a conditional expression set for each variable area. Namely, the CPU 202 selects content data according to a conditional expression, and disposes the selected content data in the variable areas 303 and 304. For example, in one instance the content data may be text data whereas in another the content data may be image data.

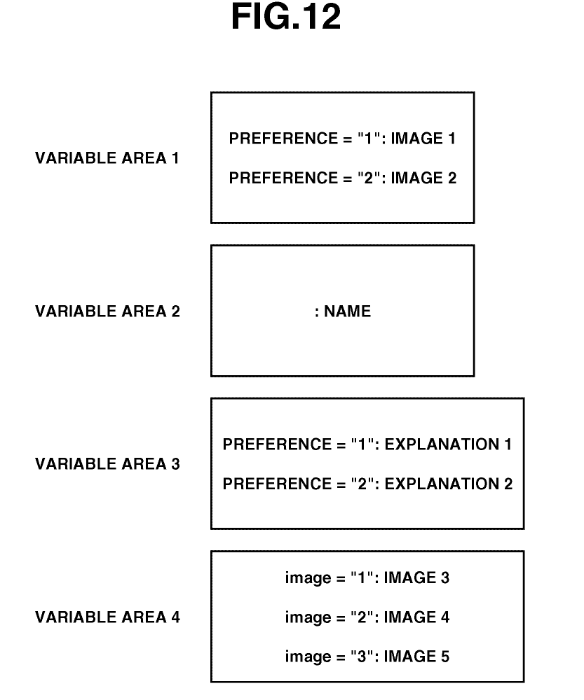

FIG. 12 illustrates examples of the conditional expression. The conditional expression is a definition for acquiring content data to be disposed in a variable area. Furthermore, if two types of records include different content data, content data disposed in respective variable areas can be changed by switching the records. Therefore, in an exemplary embodiment, the VDP system enables a user to recognize the position of the variable areas 303 and 304 on the editing screen in a state where actual data (contents of an image and a text) is not displayed. In an exemplary embodiment, the record is a data group composed of content data corresponding to a plurality of items.

The other two of the four content data areas are fixed areas 305 and 306 to which invariant content data (data not varying depending on information of a database) can be constantly applied. For example, if two records include different content data, actual data of the fixed areas do not change regardless of switching between the records. Therefore, in an exemplary embodiment, actual data (contents of an image and a text) selected and set beforehand are displayed in the fixed areas 305 and 306 respectively.

The RAM 207 stores attribute information of each area. The attribute information indicates whether the area in which content data can be disposed is a variable area or a fixed area. Furthermore, the RAM 207 stores a type (image, text, other) of actual data disposed in each variable area and a conditional expression set for each variable area. For example, according to the example of FIG. 3, the RAM 207 stores information that contents of a text file are set in the variable area 303 and contents of an image file are set in the variable area 304. Moreover, the RAM 207 stores information relating to the fixed areas 305 and 306 as well as information of a rectangular area occupied by each variable area or a fixed area, namely positional information indicating the position of each rectangular area.

The VDP application differs from an ordinary Desktop Publishing (DTP) application in that the VDP application implements a variable area. The variable area includes setting of unique information so that contents to be displayed can be changed according to the information of a database. The unique information can be expressed by a conditional expression representing a relationship between an attribute (for example, text, image, or graphic) of each area and a database.

The conditional expression can be, for example, usage of “AAA.jpg” in a specific variable area for persons in the age range between 20 and 29 inclusive, and “BBB.jpg” for other persons. If “25-year old” is set as an item indicating the age, an image file of “AAA.jpg” is disposed in the variable area to which the above-described condition is set when the VDP data is generated. If “35-year old” is set as an item indicating the age, an image file of “BBB.jpg” is disposed in the variable area when the VDP data is generated.

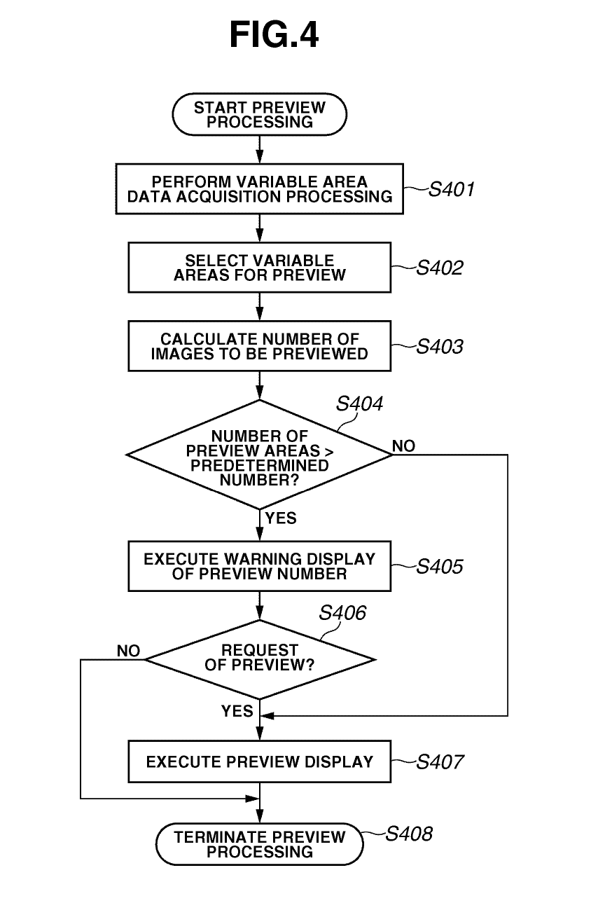

The editing screen of the VDP application is not limited to the above-described example. An exemplary preview generation function is described below. FIG. 4 is a flowchart illustrating a method for generating a preview image according to an exemplary embodiment of the present invention. The CPU 202 executes the following processing according to a VDP application.

If a user instructs preview processing via the keyboard 216 or the mouse 217, the CPU 202 executes processing of step S401 which includes acquiring data of each variable area included in a template of currently edited VDP data according to the VDP application. The data acquired by the processing of step S401 includes information which the CPU 202 requires to select an area where actual data can be displayed for a preview operation.

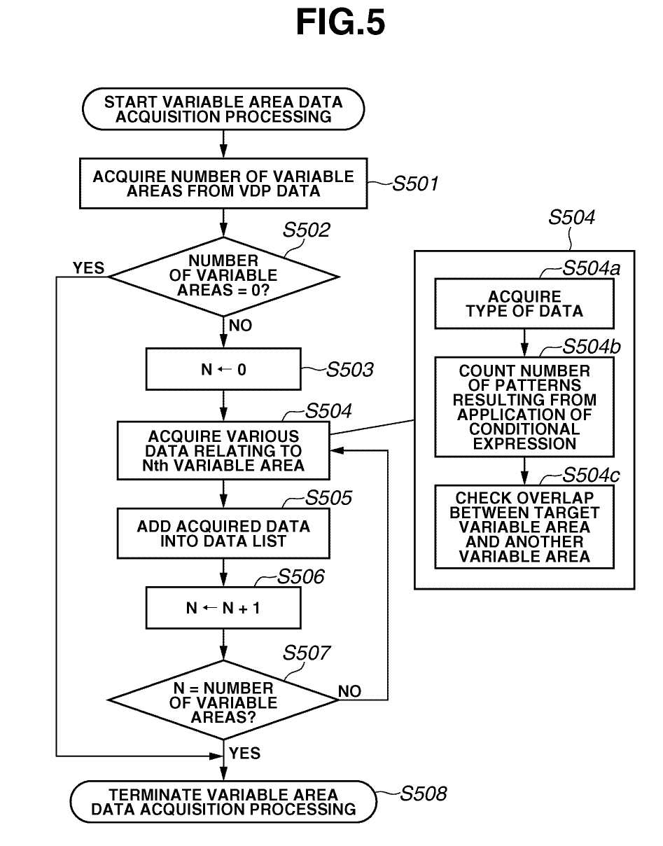

Referring now also to FIG. 5, there is shown a flowchart illustrating details of the processing performed in step S401. In step S501 of FIG. 5, the CPU 202 acquires the number of variable areas from the VDP data. In this embodiment of the present invention, the number of preview object areas is the determined number of variable areas. As described above, the RAM 207 stores attribute information. Therefore, the CPU 202 can recognize the number of variable areas based on attribute information of each area read from the RAM 207.

In step S502, the CPU 202 determines whether the number of variable areas is 0. If the CPU 202 determines that the number of variable areas is not 0, the processing flow proceeds to step S503. In step S503, the CPU 202 resets a count value N to 0. If the CPU 202 determines that the number of variable areas is 0, the processing flow proceeds to step S508. In step S508, the CPU 202 terminates the processing of step S401.

After completing the processing of step S503, the processing flow proceeds to step S504. In step S504, the CPU 202 acquires various data relating to the Nth variable area. The CPU 202 performs the processing of step S504 in the following manner. First, in step S504a, the CPU 202 acquires a type of data that can be disposed in the Nth variable area. As described above, the RAM 207 stores a type of data disposed in each variable area. Therefore, the CPU 202 can acquire type information based on the type of data read from the RAM 207.

In step S504b, the CPU 202 reads a conditional expression of each variable area from the RAM 207. The CPU 202 accesses the database server 102 and counts the number of patterns obtained (resulting) when the conditional expression is applied to the information of the database. The number of patterns indicates the number of types of content data to be disposed in the Nth variable area.

In step S504c, the CPU 202 determines whether the variable area is overlapped with another variable area. The CPU 202 can perform this determination based on the information of a rectangular area occupied by each variable area. For example, the CPU 202 can determine any overlap between the target variable area and other variable area based on coordinate values representing the position of each variable area which serves as the information of a rectangular area. Through the above-described processing of steps S504a through S504c, the CPU 202 acquires the data relating to the Nth variable area.

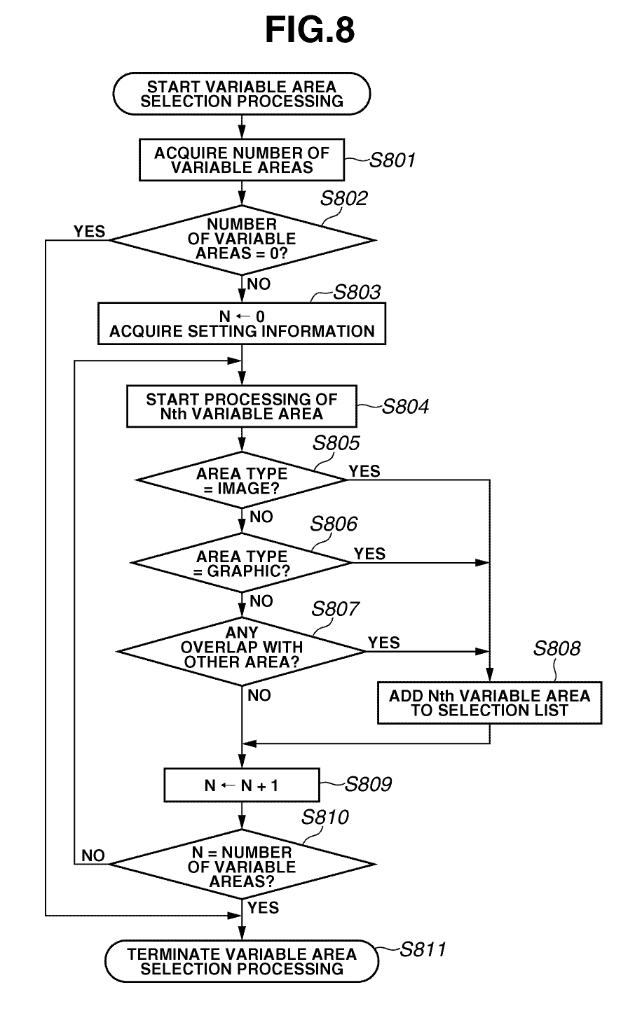

While in step S504b, the CPU 202 acquires only the number of types of content data to be disposed, the CPU 202 can acquire actual content data to be disposed in a variable area selected by later described processing of FIG. 8.

After completing the processing of step S504, the processing flow proceeds to step S505. In step S505, the CPU 202 generates a data list based on the data acquired by the processing of step S504. The RAM 207 stores the generated data list.

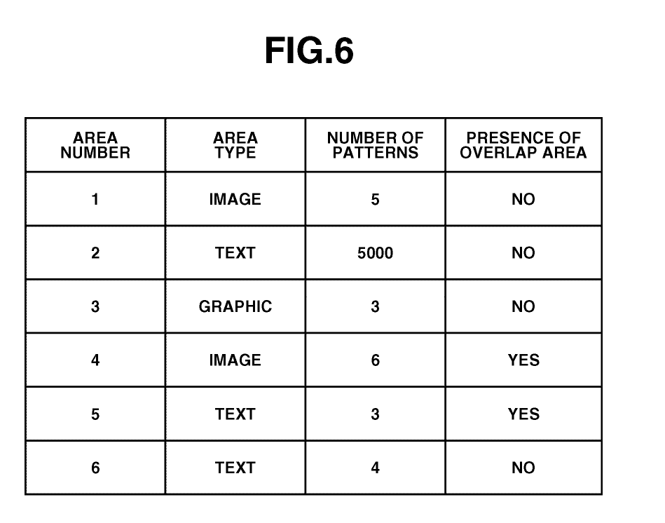

Referring now also to FIG. 6, there is illustrated an example data structure of a data list. The data list of FIG. 6 includes, for each variable area, area number of each area, type of content data disposed in each area, number of patterns of content data, presence of overlap area.

Referring again to FIG. 4 and particularly to FIG. 5, which as noted above illustrates details of the processing performed in step S401 of FIG. 4, in step S506 of FIG. 5, the CPU 202 increments the count value N by 1. In step S507, the CPU 202 determines whether the count value N accords with the number of variable areas. If the CPU 202 determines that the count value N accords with the number of variable areas (YES in step S507), the processing flow proceeds to step S508 in which the CPU 202 terminates the processing of step S401. If the CPU 202 determines that the count value N does not accord with the number of variable areas (NO in step S507), the processing flow returns to step S504. Namely, the CPU 202 repeats the processing of steps S504 through S507 until the processing for all variable areas is accomplished.

Referring still to FIG. 4, after completing the processing of step S401, the processing flow proceeds to step S402. In step S402, the CPU 202 selects at least one object area for a preview operation using actual data. Namely, the CPU 202 functions as a selection unit configured to perform a preview operation based on the data acquired by the processing of step S401. The CPU 202 performs the processing of step S402 according to conditions set beforehand by a user.

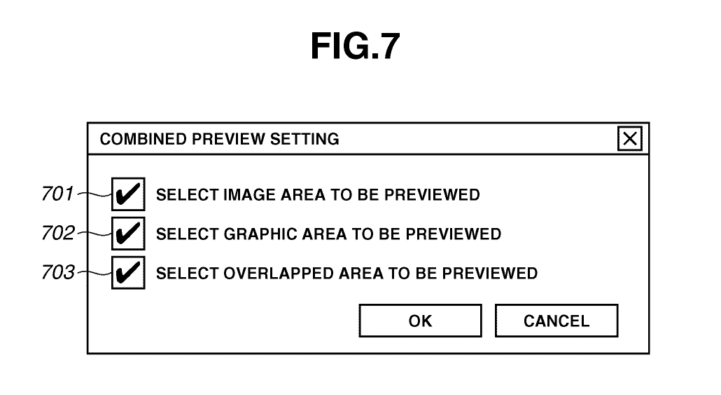

Referring now also to FIG. 7, there is illustrated an example of a user interface that the CPU 202 causes the display device 211 to display. The user interface includes three check boxes 701, 702 and 703 of three conditions that a user can set. A user can check the first check box 701 to enable a first condition “select an image area to be previewed”, the second check box 702 to enable a second condition “select a graphic area to be previewed”, and the third check box 703 to enable a third condition “select an overlapped area to be previewed.” If a user enables these conditions, the CPU 202 can generate a preview image including content data disposed in the areas corresponding to the conditions. If a user does not check one of the check boxes 701 to 703, the condition corresponding to the non-checked check box is disabled. The CPU 202 does not generate any preview image including the area corresponding to the disabled condition.

Referring now also to FIG. 8, there is shown a flowchart illustrating detailed processing of step S402 of FIG. 4. In step S801 of FIG. 8, the CPU 202 acquires the number of variable areas from the VDP data (the number of objects to be previewed). In step S802, the CPU 202 determines whether the number of variable areas is 0. If the CPU 202 determines that the number of variable areas is not 0 (NO in step S802), the processing flow proceeds to step S803. In step S803, the CPU 202 resets a count value N to 0. Then, the CPU 202 functions as an acquisition unit configured to acquire preview setting information (preview conditions) set by a user via a user interface like that of FIG. 7. If the CPU 202 determines that the number of variable areas is 0 (YES in step S802), the processing flow proceeds to step S811. In step S811, the CPU 202 determines the processing of step S402.

After completing the processing of step S803, the processing flow proceeds to step S804. In step S804, the CPU 202 starts processing for the Nth variable area. In this processing, the CPU 202 determines whether the Nth variable area can be selected as an area to be previewed in which content data can be disposed based on the data list acquired by the processing of step S401 of FIG. 4 and the preview setting information (preview conditions) acquired by the processing of step S803. The CPU 202 performs all of steps S805 through S807 of FIG. 8 when a user checks all of the check boxes 701 through 703 illustrated in FIG. 7. When fewer of those check boxes (701 through 703) are checked, then some or all of steps S805 through S807 are skipped as described below.

In step S805, the CPU 202 determines whether the type of data disposed in the Nth variable area is image. If the CPU 202 determines that the type of data is image (YES in step S805), the processing flow proceeds to step S808. In step S808, the CPU 202 selects the Nth variable area as an object of a preview operation using content data disposed in the selected area. If the CPU 202 determines that the type of data is not image (NO in step S805), the processing flow proceeds to step S806. In step S806, the CPU 202 determines whether the type of data disposed in the Nth variable area is graphic. If the CPU 202 determines that the type of data is graphic (YES in step S806), the processing flow proceeds to step S808.

In step S808, the CPU 202 selects the Nth variable area as an object of a preview operation using content data disposed in the selected area. If the CPU 202 determines that the type of data is not graphic (NO in step S806), the processing flow proceeds to step S807. In step S807, the CPU 202 determines whether the Nth variable area is overlapped with other area. If the CPU 202 determines that the Nth variable area is overlapped with other area (YES in step S807), the processing flow proceeds to step S808. In step S808, the CPU 202 selects the Nth variable area as an object of a preview operation using content data disposed in the selected area.

If the CPU 202 determines that the Nth variable area is not overlapped with another area (NO in step S807), the processing flow proceeds to step S809. In step S809, the CPU 202 increments the count value N by 1. Then, in step S810, the CPU 202 determines whether the count value N accords with the number of variable areas. After completing the processing of step S808, the CPU 202 performs the processing of steps S809 and S810. If the CPU 202 determines that the count value N accords with the number of variable areas (YES in step S810), the processing flow proceeds to step S811.

In step S811, the CPU 202 terminates the processing of step S402. If the CPU 202 determines that the count value N does not accord with the number of variable areas (NO in step S810), the processing flow returns to step S804. Namely, the CPU 202 repeats the processing of steps S804 through S810 until the processing for all variable areas is accomplished. By executing the processing of FIG. 8, the CPU 202 can select a variable area to be previewed in which content data can be disposed, from variable areas contained in a template, based on the preview conditions.

If a user does not check any one of the check boxes 701 to 703 illustrated in FIG. 7, the CPU 202 skips the above-described determination processing (steps S805 to S807) corresponding to the non-selected (i.e., disabled) condition. For example, if a user does not check the check box 701 but checks box S702, then the processing flow directly proceeds to step S806 after completing the processing of step S804, skipping step S805. Similarly, if the user does not check the check box 702 but checks box S703, then step S806 is skipped and processing continues in step S807. If check boxes S702 and S703 are both not checked, then steps S806 and S807 are both skipped and processing continues at step S809.

For example, if the processing of step S401 acquires the data list of FIG. 6 and the processing of step S803 acquires the setting information of FIG. 7, the processing of steps S804 to S808 selects variable areas corresponding to area numbers “1”, “3”, “4”, and “5.”

Referring still to FIG. 4, after completing the processing of step S402, the processing proceeds to step S403. In step S403, the CPU 202 calculates the number of areas to be previewed based on the result obtained by the processing of step S402. In this processing, the CPU 202 counts the number of patterns (a combination of actual data between variable areas) acquired by applying all information of an object database to all variable areas selected by the processing of step S402.

For example, in a situation where the data list of FIG. 6 is generated and the information of FIG. 7 is set, the variable areas having area numbers “1”, “3”, “4”, and “5” are selected as variable areas for a preview operation as described above. As illustrated in FIG. 6, the number of patterns is five if the area number is “1”, three if the area number is “3”, six if the area number is “4” and three if the area number is “5.” Accordingly, if the content data disposed in respective variable areas are completely independent from each other, the total number of patterns is equal to “270=5×3×6×3 (patterns).” Namely, in later-described step S407, the CPU 202 generates a plurality of types of data to be disposed in the variable areas selected by the processing of FIG. 8. The plurality of types of data is a combination of content data of the selected areas.

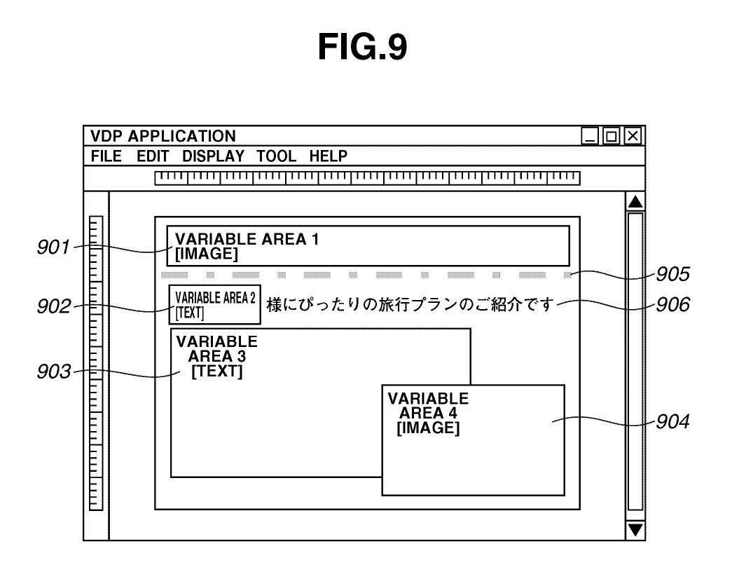

For example, a document may include two or more types of content data which are mutually related, and content data corresponding to two or more area numbers may be completely related to each other. For example, according to the above-described example, the content data of area number “3” may be completely related with the content data of area number “5.” Namely, in a case where the graphic data of area number “3” and the text data of area number “5” are completely related, the data of area number “5” can be automatically set upon determining data of area number “3.” In this case, the total number of patterns is 90 (i.e., one third of 270) patterns. More details are described with reference to FIG. 9 and below.

After completing the processing of step S403, the processing flow proceeds to step S404. In step S404, the CPU 202 determines whether the number of preview areas acquired by the processing of step S403 exceeds a predetermined number. If the CPU 202 determines that the number of preview areas exceeds the predetermined number (YES in step S404), the processing flow proceeds to step S405. In step S405, the CPU 202 causes the display device 211 to display a warning message with respect to the number of preview areas.

If the CPU 202 determines that the number of preview areas does not exceed the predetermined number (NO in step S404), the processing flow proceeds to step S407. In step S407, the CPU 202 generates preview data to be disposed in the selected variable areas (content data to be disposed in the variable areas selected by the processing of FIG. 8) and functions as a display control unit configured to cause the display device 211 to display the generated preview data. The predetermined number used in the processing of step S404 is a number determined beforehand by a user or the VDP application. This determination can be made, for example, at the user's discretion.

After the warning message is displayed in step S405, in step S406 the CPU 202 determines whether a user requests a preview operation. This is because a user may request a preview operation even if a long time is required to generate preview data and completing preview displays. If the CPU 202 determines that a user does not request a preview operation (NO in step S406), the processing flow proceeds to step S408 to terminate the preview processing. However, if the CPU 202 determines that a user requests a preview operation (YES in step S406), the processing flow proceeds to step S407.

In step S407, the CPU 202 functions as a generation unit configured to generate preview data (content data to be disposed in the variable areas selected by the processing of FIG. 8) and also functions as a display control unit configured to cause the display device 211 to display the generated preview data. Namely, the CPU 202 acquires content data to be disposed in the variable areas selected by the processing of FIG. 8 from a database and generates preview data based on the acquired content data. The generated preview data is displayed, and then processing flow proceeds to step S408 to terminate the preview processing.

In the preview display processing of step S407, the CPU 202 can use the content data selected by the processing of FIG. 8. In this case, if there is a plurality of images to be previewed, the CPU 202 causes the display device 211 to perform a slide display or a thumbnail display of the preview image.

According to an exemplary embodiment, the CPU 202 can generate preview data so that content data can be disposed in the variable areas selected by the processing of FIG. 8 and not disposed in a variable area or variable areas which are not selected. Therefore, the CPU 202 can perform a preview operation limited to a portion which a user designates, and can sufficiently confirm the layout for practical use. Furthermore, in the generation of a preview image, the CPU 202 does not generate preview data for a pattern which is not actually output and can decrease an amount of required processing.

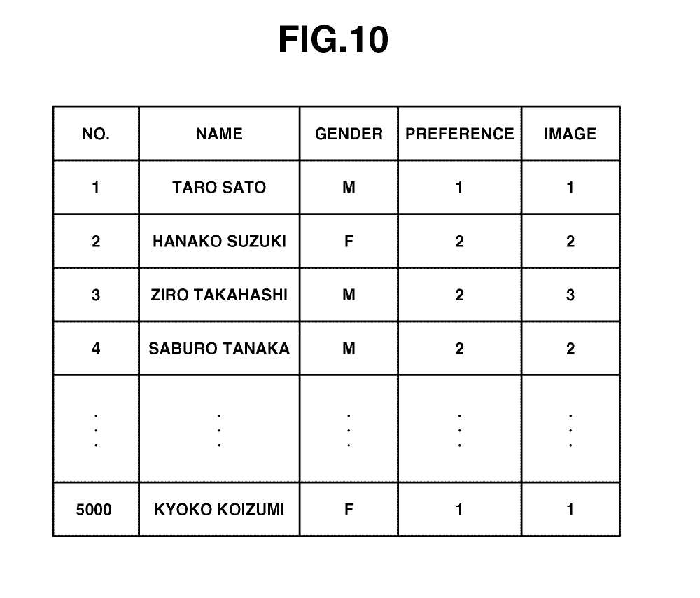

An example preview function of the VDP application according to an exemplary embodiment is described below. FIG. 9 illustrates an example editing screen that enables a user (e.g., a travel agency using a VDP application) to edit the contents of a direct mail (VDP data) to be sent to a client selected, for example, from a client database of FIG. 10. The editing screen of FIG. 9 includes a plurality of variable areas so that the contents of each direct mail can be changed according to a preference of a client.

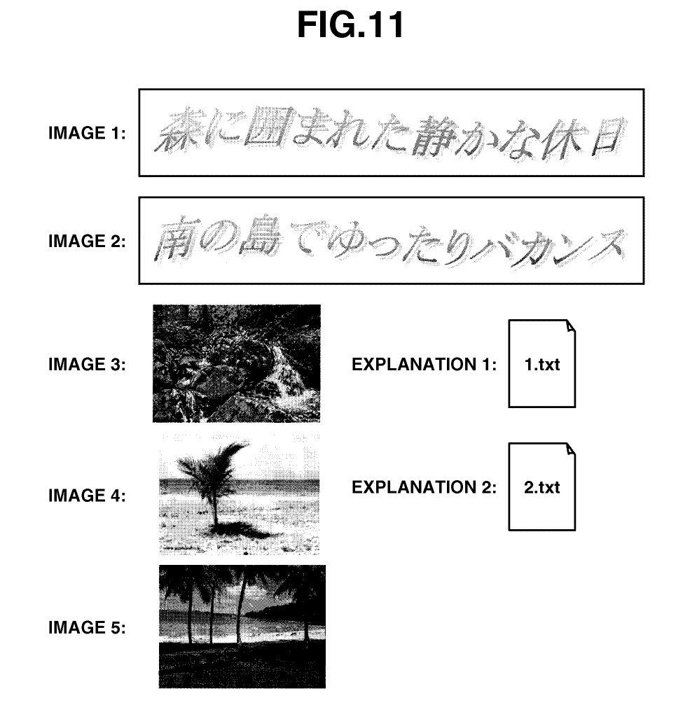

As illustrated in FIG. 9, the editing screen includes four variable areas 901, 902, 903, and 904 and two fixed area 905 and 906 which are set by a user. FIG. 11 illustrates image files and text files prepared by a user as content data to be displayed (VDP data). In FIG. 11, the left part of the mark “:” is a name (character string) of the content data and the right part of the mark “:” is an actual image or text representing the content data. These data are mutually related.

Furthermore, to determine an image or a text to be disposed, a user can set a conditional expression for each variable area as illustrated in FIG. 12. In FIG. 12, the left part of the mark “:” is a condition and the right part of the mark “:” is a name of content to be input when it accords with the condition. The conditional expression of variable area 1 indicates that, if a value in the “preference” column of a client (an object of generated VDP data) is “1”, an image named “image 1” is applied to the variable area 1. If a value in the “preference” column is “2”, an image named “image 2” is applied to the variable area 1. The conditional expression of variable area 2 does not include any condition and constantly applies a character string in the “name” column of a client as a character string of the variable area 2.

The conditional expression of variable area 3 indicates that, if a value in the “preference” column of a client is “1”, a text named “explanation 1” is applied to the variable area 3. If a value in the “preference” column is “2”, a text named “explanation 2” is applied to the variable area 3. The conditional expression of variable area 4 indicates that an image named “image 3”, “image 4”, or “image 5” is applied to the variable area 4 according to the number “1”, “2”, and “3” respectively in the “image” column of a client. In FIG. 12, the conditional expression set for each variable area may be referred to as extraction condition for extracting content data.

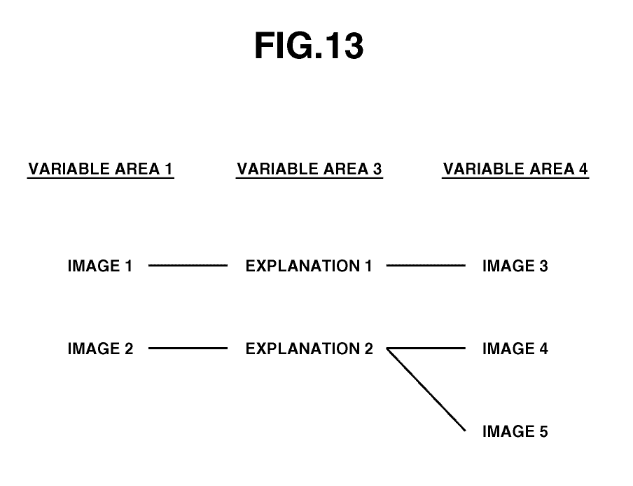

Accordingly, as illustrated in FIG. 13, the content data of variable area 1 is completely related with the content data of variable area 3. Furthermore, as apparent from FIG. 13, a user sets the conditional expression so that the “image 3” can be used only when the “image 1” is selected and both the “image 4” and the “image 5” can be used only when the “image 2” is selected.

In general, the grammar of a language used for describing a conditional expression varies dependent on each VDP application.

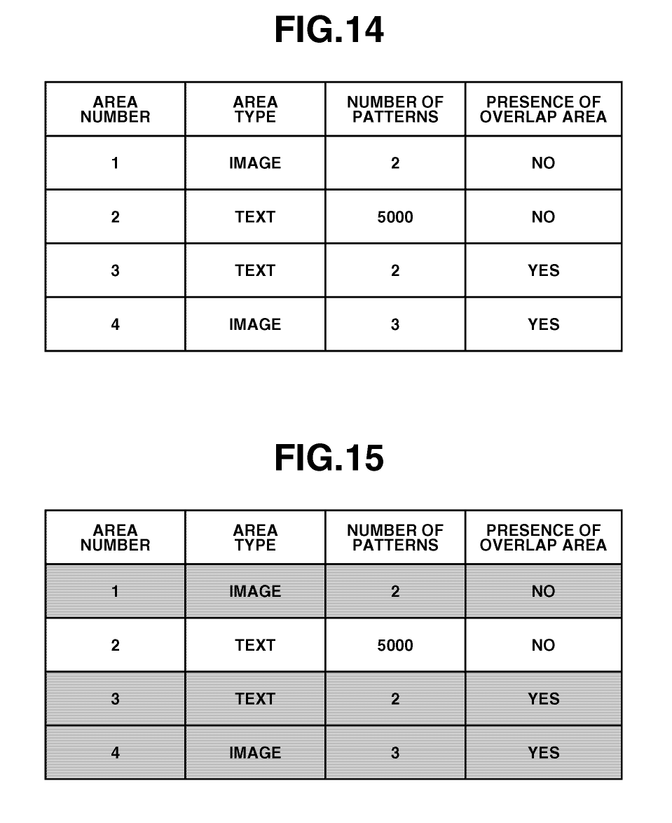

If the processing of FIG. 4 starts with the conditions of FIGS. 9 to 13, the CPU 202 generates a data list having a data structure illustrated in FIG. 14 (step S401). Next, if a user checks all check boxes 701 to 703 of FIG. 7, the CPU 202 selects three variable areas corresponding to the area numbers “1”, “3”, and “4” (variable areas in which content data can be disposed) as illustrated in FIG. 15 (step S402). Namely, the CPU 202 selects the variable area whose content data type is image (area numbers “1” and “4”) and the area overlapped with other area (area number “3”) as variable areas to be previewed using actual data.

Next, the CPU 202 calculates the number of preview displays to be previewed (step S403). In this case, the number of preview displays is equal to “12=2×2×3 (patterns)” according to a multiplication of the number of patterns in respective variable areas. However, as described above, according to the above-described example, content data in three variable areas have relevancy as illustrated in FIG. 13. Therefore, the number of preview displays can be reduced.

More specifically, according to an exemplary embodiment, if a value in the “preference” column is “1”, it indicates that a client prefers a travel to a mountain area. If a value in the “preference” column is “2”, it indicates that a client prefers a travel to a beach area. The data applied to each variable area is changeable according to a travel plan to be introduced.

For example, to introduce a recommended mountain area plan (for example, to target a client who prefers a travel to a mountain area), a travel agency (a user) can determine a conditional expression (extraction conditions) of each variable area beforehand so that a title, images, explanations and illustrations for a recommended mountain resort can be applied to pre-designated variable areas. Similarly, to introduce a recommended beach area plan (for example, to target a client who prefers a travel to a beach area), the travel agency can determine a conditional expression (extraction condition) of each variable area beforehand so that a title, images, explanations and illustrations for a recommended beach resort can be applied to pre-designated variable areas.

Accordingly, VDP data introducing a mountain resort plan can be generated for a client who has a value “1” in the “preference” column. In this case, as illustrated in FIG. 13, the possible combination of patterns is determined considering one pattern (image 1) for the variable area 1, one pattern (explanation 1) for the variable area 3, and one pattern (image 3) for the variable area 4. Namely, if a value “1” is present in the “preference” column, the number of patterns is equal to “1=1×1×1 (pattern).”

On the other hand, VDP data introducing a travel plan of a beach area can be generated for a client who has a value “2” in the “preference” column. In this case, as illustrated in FIG. 13, the possible combination of patterns is determined considering one pattern (image 2) for the variable area 1, one pattern (explanation 2) for variable area 3, and two patterns (image 4 and image 5) for the variable area 4. Namely, if a value “2” is present in the “preference” column, the number of patterns is equal to “2=1×1×2 (patterns).”

Accordingly, the total number of all patterns (the number of preview images to be actually generated and displayed) is limited to “3=1+2 (patterns).” Namely, even in a case where there are four variable areas in which numerous types (exceeding a total of 5,000 types) of content data can be disposed, the VDP system enables a user to efficiently perform layout confirmation of only three patterns based on the intent of the user.

For example, according to the list of FIG. 10, VDP data of “Hanako SUZUKI” is similar to VDP data of “Saburo TANAKA” except for the name to be disposed in the variable area 902. In this case, if a user (for example, a person who generates VDP data) wants to confirm a display of images and any overlap between the displayed images, the CPU 202 can regard and display the VDP data of “Hanako SUZUKI” and the VDP data of the “Saburo TANAKA” as same data. Thus, the CPU 202 can efficiently perform a preview operation.

As described above, the CPU 202 can generate preview data for a combination of content data extracted based on extraction conditions set for the variable areas and actually printed.

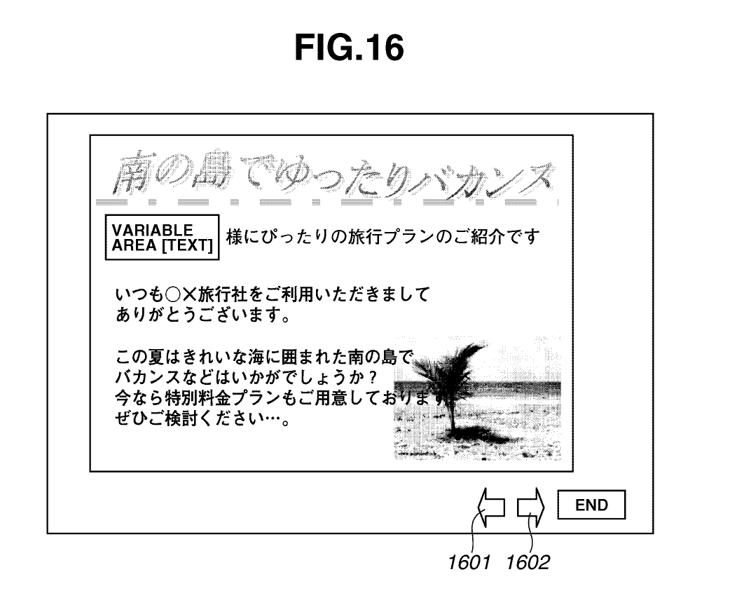

FIG. 16 illustrates an example preview display actually performed, according to which the image 2 is applied to the variable area 1(901) of FIG. 9, the explanation 2 is applied to the variable area 3 (903) of FIG. 9, and the image 5 is applied to the variable area 4 (904) of FIG. 9. The preview display of FIG. 16 includes a display of two arrows 1601 and 1602 that enable a user to switch preview displays. According to the present invention, even if a great amount of content data is stored in a database, the VDP system can efficiently perform preview processing based on preview conditions designated by a user.

A computer can execute a program to realize the above-described exemplary embodiment. An exemplary embodiment of the present invention can use a unit capable of supplying programs to a computer. For example, a CD-ROM or a computer-readable recording medium can store programs. The Internet or other transmission medium can transmit programs. In this respect, the present invention encompasses the above-described program, the recording medium, and the transmission medium as well as related software products.

Moreover, an operating system (OS) or other application software running on a computer can execute part or all of actual processing based on instructions of the programs.

Additionally, the program code read out of a storage medium can be written into a memory of a function expansion board equipped in a computer or into a memory of a function expansion unit connected to the computer. In this case, based on an instruction of the program, a CPU provided on the function expansion board or the function expansion unit can execute part or all of the processing so that the functions of the above-described exemplary embodiments can be realized.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2007-024589 filed Feb. 2, 2007, which is hereby incorporated by reference herein in its entirety.

What is claimed is:

1. An information processing apparatus operable to generate data including one or more variable areas in which content data acquired from a database can be disposed, the apparatus comprising:
a setting unit configured to set preview conditions;
a selection unit configured to select a variable area to be previewed and into which content data can be disposed, from the one or more variable areas, based on the preview conditions;
a generation unit configured to generate content data to be disposed in the variable area selected by the selection unit as preview data disposed in the variable area; and
a display control unit configured to cause a display device to display the preview data,
wherein the generation unit generates a plurality of preview data as a combination of content data disposed in each variable area, and
the display control unit causes the display device to display the plurality of preview data generated by the generation unit.

2. The information processing apparatus according to claim 1, wherein if the setting unit sets the preview conditions including a preview of a variable area where image data is disposed, the selection unit selects a variable area having a setting of attribute indicating that the image data can be disposed.

3. The information processing apparatus according to claim 1, wherein if the setting unit sets the preview conditions including a preview of a variable area in the preview data which is overlapped with other area, the selection unit selects a variable area which is overlapped with other area.

4. The information processing apparatus according to claim 1, wherein the generation unit generates preview data so that content data to be disposed in the variable area can be disposed in the variable area selected by the selection unit and not disposed in an area which is not selected by the selection unit.

5. The information processing apparatus according to claim 1, wherein the setting unit sets extraction conditions for extracting content data for the variable area, and the generation unit generates preview data for a combination of content data to be actually printed based on the extraction conditions.

6. The information processing apparatus according to claim 1, further comprising a warning unit configured to generate a warning for a user if the number of the preview data exceeds a predetermined value.

7. The information processing apparatus according to claim 1, wherein the data includes, in addition to the variable area, one or more fixed areas in which invariant content data can be disposed.

8. The information processing apparatus according to claim 1, further comprising an acquisition unit configured to acquire, from the database, content data to be disposed in the variable area selected by the selection unit, wherein the generation unit generates preview data from the content data acquired by the acquisition unit.

9. The information processing apparatus according to claim 1, wherein if the setting unit sets the preview conditions including a preview of a variable area where graphic data is disposed, the selection unit selects a variable area having a setting of attribute indicating that the graphic data can be disposed.

10. A method for controlling an information processing apparatus operable to generate data including one or more variable areas in which content data acquired from a database can be disposed, the method comprising:
setting preview conditions;
selecting a variable area to be previewed and into which content data can be disposed, from the one or more variable areas, based on the preview conditions;
generating content data to be disposed in the selected variable area as preview data disposed in the variable area;
causing a display device to display the preview data;
generating a plurality of preview data as a combination of content data to be disposed in each variable area; and
causing the display device to display the generated plurality of preview data.

11. A storage medium storing a computer-readable program, when installed on a computer, causing the computer to generate data including one or more variable areas in which content data acquired from a database can be disposed, the medium storing:
computer-executable instructions for setting preview conditions;
computer-executable instructions for selecting a variable area to be previewed and into which content data can be disposed, from the one or more variable areas, based on the preview conditions;
computer-executable instructions for generating content data to be disposed in the selected variable area as preview data disposed in the variable area;
computer-executable instructions for causing a display device to display the preview data;
computer-executable instructions for generating a plurality of preview data as a combination of content data disposed in each variable area; and
causing the display device to display the generated plurality of preview data.
